(19) United States
(12) Patent Application Publication
(10) Pub. No.: US 2019/0077340 A1
(43) Pub. Date: Mar. 14, 2019

(54) TRIM ELEMENTS FOR VEHICLE PASSENGER COMPARTMENT COMPRISING A PIEZOELECTRIC MEMBER

(71) Applicant: Faurecia Interieur Industrie, Nanterre (FR)

(72) Inventors: Cedric CARAVANO, SAINT GERMAIN EN LAYE (FR); Marion BUHANNIC, LANNION (FR); Omar BEN ABDELAZIZ, BEAUVAIS (FR); Etienne POULET, SAINT BRESSON (FR)

(21) Appl. No.: 16/125,273

(22) Filed: Sep. 7, 2018

(30) Foreign Application Priority Data
Sep. 8, 2017 (FR) 17 58323

(51) Int. Cl. B60R 16/023; B60R 13/02; B60R 16/03; B60N 2/90

(52) U.S. Cl. CPC B60R 16/023; B60R 13/02; B60R 16/03; B60N 2/90; B60N 2/80; B60R 13/0243; B60R 13/0262; B60R 13/0256; B60R 2013/0287; B60R 13/0212

(57) ABSTRACT

A trim element for a vehicle includes a cover, a piezoelectric member and a wireless telecommunication device. The cover has a face surface intended to be in contact with a user and a back surface on the opposite side, and the cover has a layer of foam and a covering material. The piezoelectric member is intended to be actuated by the user. The wireless telecommunication device is controlled by the piezoelectric member and adapted for communicating with an electrically controlled functional device for controlling the electrically controlled functional device. The telecommunication device is attached to the back surface of the cover.

### FIELD OF THE INVENTION

The invention relates to vehicles and vehicle passenger compartments. The invention more specifically relates to trim elements arranged in vehicle passenger compartments. The invention in particular relates to seats placed in vehicle passenger compartments. The invention also relates to a command for a functionality of such trim elements.

### BACKGROUND

The vehicle passenger compartment generally comprises a set of members bearing one or more functionalities. The compartment in particular comprises at least a door panel, a console, a headliner and an instrument panel. Further, the passenger compartment also includes at least a seat intended for a driver or passenger of the vehicle, hereafter designated by the term user. These members generally comprise at least one trim element which has for example the form of a fabric or plastic covering. Thus, the invention applies to any member of the passenger compartment which comprises a trim element.

In particular, the seat can be intended for a single person, when it involves an individual seat, for example placed in the front of the vehicle. The seat can also be part of a bench which could receive several people, when it involves, for example, a rear bench of a vehicle. Thus, in the meaning of the invention, the term “seat” designates both an individual seat, a part of a bench and the bench itself. The seat usually comprises several assembled seat elements. The set of seat elements comprises at least one seatback and one seat bottom. Optionally, the assembly also includes a headrest and/or neck support and/or armrest. The seat can also include other seat elements.

Additionally, each seat element principally comprises a bearing structure whose function is to provide the seat element an adequate structural reinforcement. The bearing structure may be either connected to another bearing structure of another seat element, or fixed to a floor of the passenger compartment, for example by means of a sliding track. The seat element can also include a padding resting on the bearing structure. The padding typically comprises a soft material and has the function of increasing the comfort of the user of the seat element. Further, the seat element comprises a cover, generally of fabric which envelops the padding and/or the bearing structure. The cover is thus disposed between the padding and/or the bearing structure and the user and the function thereof is to protect the padding.

Further, the seat generally comprises several functions. For example, the seat comprises a function of adjusting the inclination of the seatback relative to the seat bottom. The seat can also comprise a massage function, for example by providing in the padding a cushion comprising several pockets that are alternately inflated and deflated. These functionalities are implemented by functional devices.

In the same way, the door panel, console, headliner and instrument panel also comprise at least one functional device. The door panel could comprise a functional device for adjusting the degree of opening of the window in the door. Similarly, the headliner also comprises a functional device for turning on or off a light mounted in the headliner.

To control these functional devices, a control device is generally provided in the passenger compartment, for example on the instrument panel. A control device for one or more functionalities could also be provided on the trim element. The control device comprises at least one button with which to control the functional device, and also an electrical connection between the button and the functional device. This connection is done by means of several electrical cables, which makes the integration of the functional device in the passenger compartment more complex.

### OBJECT AND SUMMARY

One goal of the invention is to provide a trim element which is easily integrated into the architecture of the passenger compartment without losing functionality.

To do that, in accordance with an aspect of the invention, there is provided a vehicle trim element comprising:
a cover comprising a face surface intended to be in contact with the user and a back surface, where the back surface is on the opposite side from the face surface and where the cover comprises a layer of foam and a covering material;
a piezoelectric member to be actuated by the user; and
a wireless telecommunication device controlled by the piezoelectric member and adapted for communicating with an electrically controlled functional device for controlling it, where the telecommunication device is attached to the back surface of the cover.

The cover described above can in particular be the cover known under the tradename Cover Carving Technology also designated by the abbreviation CCT. It is stiffer than a fabric cover. Thus, it serves to house the telecommunication device and protect it. The telecommunication device can thus be disposed near the piezoelectric member. The cover thus implemented therefore serves to reliably house a wireless telecommunication device in the seat element.

Thus, the user of the trim element can control the electrically controlled functional device by means of the piezoelectric member. The order issued by the user, by means of the piezoelectric member, can be transmitted with the wireless telecommunication device to the electrically controlled functional device. Further, it is not necessary to provide a rechargeable battery or a specific energy supply. In fact, the action of the user on the piezoelectric member serves to confer the telecommunication device the energy necessary for its operation. Further, as the communication between the telecommunication device and the electrically controlled functional device is wireless, it is not necessary to provide cabling between these two members. It will of course be noted that the electrically controlled functional device can be carried by the trim element but also be arranged away from it on another member of the passenger compartment of the vehicle.

Further, in various embodiments of the invention, the trim element may include one or more of the following features:
the foam layer essentially comprises polyurethane;
the covering material is a fabric material;
the covering material is a synthetic material;
the covering material is a skin;
the cover is made by cold forming of the foam sprayed on a substrate and brought onto the back surface of the covering material;
the cover can have a thickness included between 1 mm and 50 mm; the thickness of the cover can also vary with the zone of the cover;
the electrically controlled functional device is distinct from the wireless telecommunication device;
the electrically controlled functional device extends away from the wireless telecommunication device;
the piezoelectric member is a switch;
the piezoelectric member is a push-button;
the piezoelectric member comprises a plurality of buttons;
the piezoelectric member is also fixed to the back surface of the cover;
a portion of the face surface of the cover covering the piezoelectric member comprises a three-dimensional shape defining a pressing area for the user of the trim element; it will be noted that the cover has sufficient stiffness to comprise a zone which has a specific three-dimensional shape thus defining the pressing area for the user; for example, the specific shape is a succession of concentric waves;
the cover comprises a cut-out in which a piezoelectric member is housed, such that the piezoelectric member is directly accessible to the user of the trim element;
the foam layer comprises a cut-out in which the wireless telecommunication device is housed;
the piezoelectric member and the telecommunication device form a single block;
the telecommunication device includes a transmitter;
the telecommunication device includes a receiver;
the telecommunication device includes a microprocessor;
the telecommunication device includes a printed circuit;
the telecommunication device communicates with the functional device with a Wi-Fi protocol and/or with a Bluetooth protocol;
the functional device is a massage device.

According to an aspect of the invention, a vehicle passenger compartment comprising a trim element such as previously described is also provided.

Further, the trim element can be part of at least one among a door panel, console, headliner and instrument panel.

According to another aspect of the invention, a vehicle passenger compartment comprising at least one seat such as previously described is also provided.

Also according to an aspect of the invention, a seat element for a vehicle is also provided comprising:
a bearing structure;
a padding born on the bearing structure; and
at least one trim element having the above mentioned technical features, such that the cover envelops the padding.

Further, in various embodiments of the invention, one or more of the following features may be included:
the seat element is chosen among a seat bottom, seatback, headrest, armrest and a neck support;
the cover is sewn to the padding;
the cover comprises at least one self-gripping strip attaching the cover to the padding;
the functional device is a device for adjusting a position of the seat armrest relative to a seatback of the seat.

Further, according to another aspect of the invention, a vehicle passenger compartment comprising a seat element such as previously described is also provided.

Further, in various embodiments of the invention, one or more of the following features may be included:
the functional device is a device for adjusting a position of the seatback of the seat relative to a seat bottom of the seat;
the functional device is a device for adjusting a temperature regulation system of the seat;
the functional device is a device for adjusting a ventilation system of the seat;
the functional device is carried by a second seat element distinct from the seat element which carries the telecommunication device;
the second seat element is chosen among a seat bottom, seatback, headrest, armrest and a neck support.

Finally, according to an aspect of the invention, a method for manufacturing a trim element above is provided comprising at least the following steps:
the cover is made by cold forming a foam sprayed on a substrate and brought onto the back surface of a covering material; and
the telecommunication device is fixed to the back surface of the cover.

Further, in various embodiments of the method, one or more of the following features may be included:
the foam essentially comprises polyurethane;
the cold shaping of the foam sprayed on the substrate and brought onto the back surface of the covering material is done in a mold;
the telecommunication member is adhered to the back of the cover;
the substrate is a film which comprises polypropylene;
the covering material is a fabric material;
the covering material is a synthetic material;
the covering material is a skin;
the cover is sewn to the padding;
the cover is attached to the padding by at least one self-gripping strip.

### BRIEF DESCRIPTION OF THE DRAWINGS

An embodiment of the invention is now going to be described, as a non-limiting example, with the help of the following drawings:

FIG. 1 is a perspective view of the vehicle passenger compartment comprising a seat according to the invention;

FIG. 2 is a perspective view of the seat;

FIG. 3 is a block diagram of an electrically controlled functional device for the seat;

FIG. 4 is a top view of a piezoelectric member for the seat; and

FIG. 5 is a top view of a wireless telecommunication device for the seat;

FIG. 6 is a schematic representation in section along the line labeled VI-VI in FIG. 2.

FIG. 7 is a schematic representation in section along the line labeled VII-VII in FIG. 2.

### DETAILED DESCRIPTION OF AN EMBODIMENT OF THE INVENTION

In the interest of clarity, only the elements useful to understanding the embodiments described have been shown and will be described in detail.

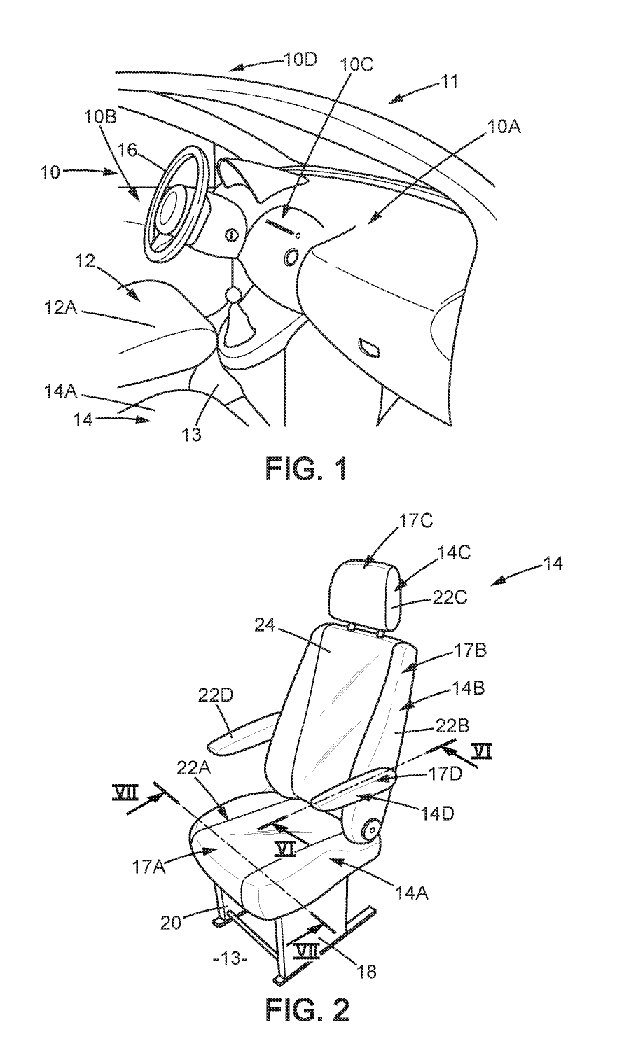

FIG. 1 shows a passenger compartment 10 of the vehicle 11 according to an embodiment of the invention. The passenger compartment 10 in particular comprises an instrument panel 10A, a door panel 10B, a center console 10C and a headliner 10D. Further, the passenger compartment 10 comprises, with reference to a direction of forward movement of the vehicle, a left front seat 12 and a right front seat 14. The left front seat 12 is disposed facing a steering wheel 16 of the vehicle 11 and thus forms a driver's seat. The right front seat 14, placed to the right of the left front seat 12, forms of front passenger seat. In this embodiment, the vehicle 11 is a sedan-type car. Note that the vehicle 11 can be any type. As can be seen in FIG. 1, the left front seat 12 and the right front seat 14 each comprise a respective seat bottom 12A, 14A.

The right front seat 14 is now going to be described in more detail with the help of FIG. 2.

As previously indicated, the seat 14 comprises a seat bottom 14A and also a seatback 14B complementarity to the seat bottom. It also comprises a headrest 14C and also two armrests 14D arranged respectively to the left and right of the seatback 14B. The seat bottom 14A, the seatback 14B, the headrest 14C and the two armrests 14D form seat elements of the seat 14. Assembled, they in fact form the seat 14 as seen in FIG. 2.

Each seat element, specifically the seat bottom 14A, the seatback 14B, the headrest 14C and the two armrests 14D comprise a bearing structure 50A, 50B, 50D and a respective cover 17A, 17B, 17C and 17D. The seat bottom 14A further comprises a padding 56A as does the seatback 14B.

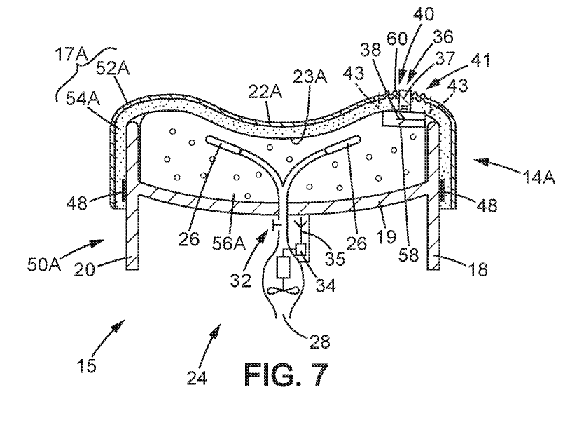

The bearing structure 50A, 50B, 50D gives the seat element the necessary structural strength. The structure is in particular configured for being joined, either to a bearing structure of another seat element (e.g. the bearing structure 50D of the armrest 14D is rotatably mounted on the bearing structure 50B of the seatback 14B), or the floor 13 of the passenger compartment 10 of the vehicle 11. In FIG. 2, two feet 18, 20 are shown which serve to connect the bearing structure 50A of the seat bottom 14A to the floor 13 of the passenger compartment 10. As shown in FIG. 7, the bearing structure 50A of the seat bottom 14A further comprises the feet 18, 20, and a crosspiece 19 connecting the feet 18, 20. The bearing structure can be of any type and can in particular comprise a metal frame.

The padding 56A provides for the comfort of the user of the seat element. It is configured to serve to support the user. The padding 56A is in fact born by the bearing structure 50A. In particular it comprises a flexible and damping synthetic foam layer.

The covers 17A, 17B, 17C and 17D surround the respective padding of the seat bottom 14A and seatback 14B, and the bearing structures of the headrest 14C and the two armrests 14D. The covers 17A, 17B, 17C and 17D further have a function of protecting the respective padding 56A and of forming an interface between the respective padding 56A and the user of the seat 14. Thus, the covers 17A, 17B, 17C and 17D comprise a face surface respectively 22A, 22B, 22C and 22D intended to be in direct contact with the user and a back surface 23A, 23D opposite the face surface. The covers 17A, 17B, 17C and 17D comprise a covering material 52A, 52D and a foam layer 54A, 54D. In this embodiment, the covering material 52A, 52D is a fabric and the foam layer 54A, 54D is a polyurethane foam layer as is going to be described later. Thus, the covers 17A, 17B, 17C and 17D have a greater stiffness than a cover formed primarily of fabric material. The covers 17A, 17B, 17C and 17D are attached to the respective padding of the seat elements 14A, 14B, 14C, 14D of the seat 14 by at least one line of sewing or by at least one self-gripping strip 48. Alternatively, they can be directly adhered to the respective padding or bearing structures.

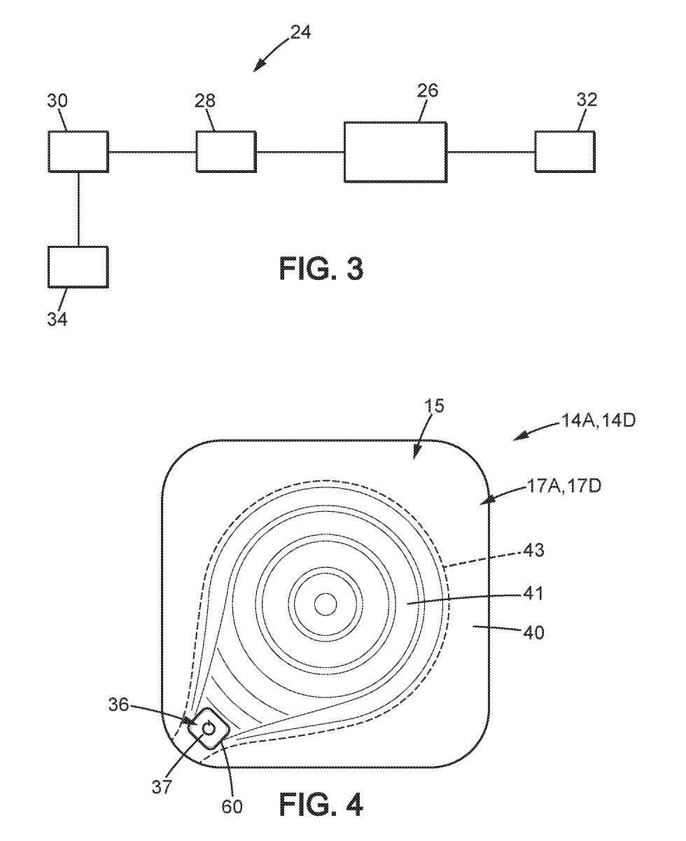

Further, the seat 14 comprises an electrically controlled massage device 24 suited for executing a massage function from the seat bottom 14A. Thus, the electrically controlled massage device 24 is housed in the seat bottom 14A of the seat 14. The electrically controlled massage device 24 is shown in FIG. 3 in the form of a block diagram. The electrically controlled massage device 24 is also shown schematically in FIG. 7. It comprises several pockets 26 that can be inflated and deflated sequentially and in alternation, an air inlet 28 for supplying the pockets 26 with air, a blower 30 able to direct air towards the air inlet 28, an air outlet 32 and a control device 34 for the blower 30. The control device 34 comprises a wireless receiver 35. Note that any type of electrically controlled functional device may be used for the seat 14.

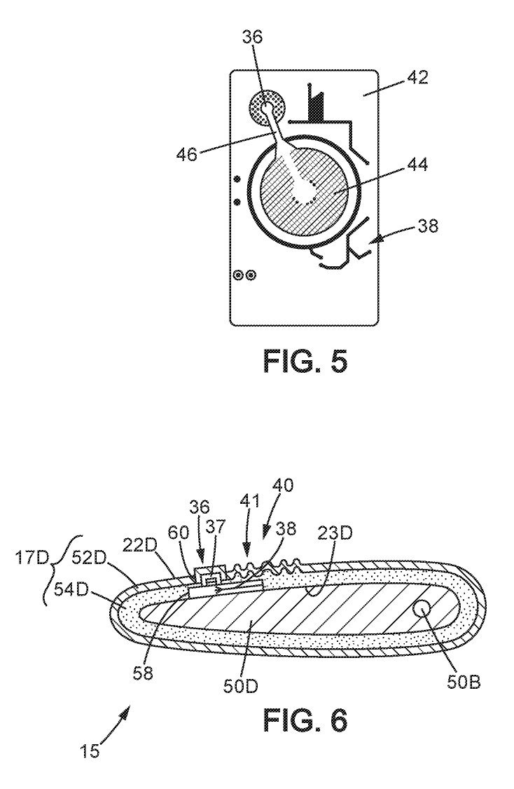

Further, the seat comprises means for control of the electrically controlled massage device 24. These means are borne by one of the armrests 14D, in the case at hand the right armrest with reference to the direction of forward movement of the vehicle 11, and by the seat bottom 14A. These means comprise a piezoelectric member 36, visible in FIG. 4, and a wireless telecommunication device 38, visible in FIG. 5, covered by a portion 40 of the face surface 22D of the cover 17D.

Further, as shown in FIGS. 4, 6 and 7, the wireless telecommunication device 38 is fixed to the back surface 23A, 23D of the cover 17D. It is also housed in a housing 58 delimited by a cut-out formed in the padding 56A and/or in the form layer 54A.

Further, the portion 40 of the face surface 22A, 22D of the cover 17A, 17D, which covers over the wireless telecommunication device 38, comprises a three-dimensional pattern 41, which here has the shape of a succession of concentric waves. This three-dimensional pattern 41 shows the user the presence of the wireless telecommunication device 38, which has the effect of improving the quality perceived by the user. Further, the pattern 41 is delimited by a line of sewing 43.

The piezoelectric member 36 here has the shape of a switch button. It comprises a plastic body 37, visible in FIG. 4, and directly accessible to the user. To do that, the cover 17A, 17D comprises a cut-out 60 in which the piezoelectric member 36 is housed. The user of the seat 14 can exert a pressure on the body 37 for actuating the piezoelectric member 36. Further, the piezoelectric member 36 controls the wireless telecommunication device 38.

In that way, the cover 17A, 17D, piezoelectric member 36 and the wireless telecommunication device 38 form trim elements 15 of the seat 14.

As shown in FIG. 5, the wireless telecommunication device 38 comprises a printed circuit 42, a wireless transmitter 44 and a wired connection 46 to the piezoelectric member 36. Thus, the piezoelectric member 36 is configured for providing the wireless telecommunication device 38 electric energy necessary for operation thereof. The printed circuit 42 controls the transmitter 44. Further, the wireless telecommunication device 38 is suited for communicating with the electrically controlled massage device 24 and does so in order to control it. Thus, the transmitter 44 is able to transmit an order intended for the receiver 35 of the control device 34 of the electrically controlled massage device 24. The printed circuit 42 of the wireless telecommunication device 38 bears the piezoelectric member 36 such that the piezoelectric member 36 and the wireless telecommunication device 38 are securely joined.

The operation of the seat 14 is now going to be described, in particular for actuating the electrically controlled massage device 24.

When the user wishes to actuate the electrically controlled massage device 24, they exert pressure on the body 37 of the piezoelectric member 36 so as to actuate the piezoelectric member 36. Thus, the piezoelectric member 36 generates an electric voltage.

Consequently, the piezoelectric member 36 both provides the wireless telecommunication device 38 energy necessary for the operation thereof. Thus, the energy provided by the user when they exert pressure on the body 37 is recovered for powering the wireless telecommunication device 38. And also, the piezoelectric member 36 commands the wireless telecommunication device 38 to send the message intended for the electrically controlled massage device 24.

Thus, the printed circuit 42 of the wireless telecommunication device 38 generates a message sent by the transmitter 44. The message is received by the receiver 35 of the control device 34 of the electrically controlled massage device 24. The electrically controlled massage device 24 is thus actuated. The control device 34 actuates the blower 30 such that the user starts to feel the massaging effect.

When the user wishes to stop the electrically controlled massage device 24, they press again on the body 37 of the piezoelectric member 36. Thus, the transmitter 44 of the wireless telecommunication device 38 sends a message intended for the receiver of the control device 34 of the electrically controlled massage device 24. Thus, the control device 34 stops the blower 30. The electrically controlled massage device 24 is thus deactivated.

A fabrication method for the seat bottom 14A and the right armrest 14D is now going to be described.

The bearing structure 15A, 50D and the padding 56A are made in any order.

To make the cover 17A, 17D, a foam 54A, 54D essentially comprising polyurethane in a pulverulent state is sprayed on a substrate which is in the form of a polyethylene and/or polypropylene film. The foam 54A, 54D, still in the pulverulent state, and the film are brought onto the back surface of a fabric material 52A, 52D such that the foam 54A, 54D is disposed, or sandwiched, between the film and the fabric material 52A, 52D. Then, the assembly formed by the foam 54A, 54D in the pulverulent state, the film and the fabric material 52A, 52D is placed in a mold configured for giving the cover 17A, 17D the final shape thereof. The cut-out 60 is provided in particular so as to dispose the piezoelectric member 36. Next, wait until the foam 54A, 54D polymerize as to a degree at least equal to 90% by mass. Then, the assembly is extracted from the mold. In that way, the cover 17A, 17D is cold formed.

Then, the wireless telecommunication device 38 is fixed to the back surface 23A, 23D of the cover 17A, 17D. This attachment can be done by adhering or by at least one self-gripping strip 48.

As the piezoelectric member 36 is securely joined to the telecommunication device 38, the piezoelectric member 36 is also positioned relative to the cover 17A, 17D.

Next, the cover 17A is attached to the padding 56A and the cover is attached to the bearing structure 50D, by sewing or adhering.

Then, the padding 56A and the cover 97A are attached to the bearing structure 50A.

Alternatively, the padding 56A is first fixed to the bearing structure 50A, and then the cover 17A is fixed to the padding 56A.

Thus, the seat bottom 14A and the right armrest 14D are made.

A fabrication method for the seat 14 which comprises the steps of fabrication of the seat bottom 14A and the right armrest 14D such as described above can also be defined.

Of course, many variants can be made to the invention without going outside the scope thereof nor the spirit thereof.

According to a variant, the wireless telecommunication device 38 and the piezoelectric member 36 form a single block.

According to another variant, the piezoelectric member 36 is also fixed to the back surface of the cover 17A, 17D. Thus, a three-dimensional shape which delimits a pressing area for the user of the seat can be provided on a portion 40 of the face surface 22A, 22D of the cover 17A, 17D which covers the piezoelectric member 36. The user of the seat 14 can exert a pressure on the pressing area 40 for actuating the piezoelectric member 36. The three-dimensional shape can then serve as a means for locating the piezoelectric member 36 in the seat 14 which improves the ergonomics thereof.

Also note that the piezoelectric member 36 can comprise a plurality of buttons.

Further, note that in this embodiment, the seat 14 is what comprises the trim element 15.

Of course, the instrument panel 10A and/or the door panel 10B and/or the central console 10C and/or the headliner 10D can also comprise the trim element 15.

1. A trim element for a vehicle comprising:
a cover comprising a face surface intended to be in contact with a user and a back surface on the opposite side, the cover comprising a layer of foam and a covering material;
a piezoelectric member to be actuated by the user; and
a wireless telecommunication device controlled by the piezoelectric member and adapted for communicating with an electrically controlled functional device for controlling said electrically controlled functional device, the telecommunication device being attached to the back surface of the cover.

2. The trim element according to claim 1, wherein the foam layer essentially comprises polyurethane.

3. The trim element according to claim 2, wherein the cover is made by cold forming of the foam sprayed on a substrate and brought onto the back surface of the covering material.

4. The trim element according to claim 1, wherein the piezoelectric member is also fixed to the back surface of the cover.

5. The trim element according to claim 4, wherein a portion of the face surface of the cover covering the piezoelectric member comprises a three-dimensional shape defining a pressing area for the user of the trim element.

6. The trim element according to claim 5, wherein the face surface of the cover comprises, in said pressing area, a succession of concentric waves forming projections.

7. The trim element according to claim 1, wherein the cover comprises a cut-out in which a piezoelectric member is housed, such that the piezoelectric member is directly accessible to the user.

8. The trim element according to claim 1, wherein the foam layer comprises a cut-out forming a housing in which the wireless telecommunication device is housed.

9. The trim element according to claim 1, wherein the piezoelectric member and the wireless telecommunication device form a single block.

10. The trim element according to claim 1, wherein the electrically controlled functional device is a massage device.

11. The trim element according to claim 1, wherein the telecommunication device communicates with the functional device with a Wi-Fi protocol.

12. The trim element according to claim 1, wherein the telecommunication device communicates with the functional device with a Bluetooth protocol.

13. A seat element for a vehicle comprising:
a bearing structure,
a cover comprising a face surface intended to be in contact with a user and a back surface on the opposite side and where the cover comprises a layer of foam and a covering material;
a piezoelectric member to be actuated by the user; and
a wireless telecommunication device controlled by the piezoelectric member and adapted for communicating with an electrically controlled functional device for controlling said electrically controlled functional device, the telecommunication device being attached to the back surface of the cover.

14. The seat element according to claim 13, comprising a padding born on the bearing structure; and the cover enveloping the padding.

15. The seat element according to claim 13, wherein the seat element is chosen among a seat bottom, seatback, headrest, armrest and a neck support.

16. A vehicle passenger compartment comprising:
a bearing structure; and
at least one trim element;
the trim element comprising:
a cover comprising a face surface intended to be in contact with a user and a back surface on the opposite side and where the cover comprises a layer of foam and a covering material;
a piezoelectric member to be actuated by the user; and
a wireless telecommunication device controlled by the piezoelectric member and adapted for communicating with an electrically controlled functional device for controlling said electrically controlled functional device, the telecommunication device being attached to the back surface of the cover.

17. The vehicle passenger compartment according to claim 16, wherein the trim element are part of at least one among a door panel, console, headliner and instrument panel.

18. The vehicle passenger compartment according to claim 16 comprising a seat, the seat comprising a seat element, the seat element comprising the bearing structure and the trim element.

19. The vehicle passenger compartment according to claim 16, wherein the seat element further comprises a padding born on the bearing structure; and the cover enveloping the padding.
